(19) United States
(12) Patent Application Publication
(10) Pub. No.: US 2026/0319696 A1
(43) Pub. Date: Oct. 15, 2026

(54) INFORMATION PROCESSING APPARATUS, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventors: MOTOKI YOSHINAGA, Kanagawa (JP); MASAMI KATO, Kanagawa (JP)

(21) Appl. No.: 19/644,988

(22) Filed: Apr. 10, 2026

(30) Foreign Application Priority Data
Apr. 15, 2025 (JP) 2025-067036

(51) Int. Cl. G06F 3/06

(52) U.S. Cl. CPC G06F 3/0655; G06F 3/0604; G06F 3/0673

(57) ABSTRACT

There is provided with an information processing apparatus. A first memory controlling unit holds, in a first partial area in a memory, a first computation result of an end node of each of a plurality of processing node groups obtained by dividing the plurality of processing nodes connected in the hierarchical manner, the first computation result corresponding to a first unit of processing. A second memory controlling unit holds, in a second partial area in the memory, a second computation result corresponding to a second unit of processing. The second memory controlling unit releases the second computation result stored in the second partial area for each computation of the first unit of processing.

### BACKGROUND

### Field of the Technology

The present disclosure relates to an information processing apparatus, an information processing method, and a non-transitory computer-readable storage medium.

### Description of the Related Art

There is demand for a hardware implementation technique for reducing memory usage while performing processing in neural networks (NNs). One obstacle to improvement of recognition performance in an NN is an increase in the amount of use of a memory for storing feature data, that is to say, layer-by-layer intermediate results (hereinafter referred to as a feature data memory).

The following Expression (1) represents an expression for using pieces of feature data X^{L}₀, X^{L}₁, X^{L}₂, . . . of a certain layer L to obtain the i^{th} feature data X^{L+1}ᵢ, of the next layer L+1.

$${X}_{i}^{L + 1} = φ ( {\sum }_{j}^{{N}_{w}} ( {W}_{i , j}^{L} \times {X}_{j}^{L} ) + {b}_{i}^{L} ) \qquad Expression ( 1 )$$

In Expression (1), W^{L}_{i,j} is a convolutional filter coefficient (hereinafter simply referred to as a coefficient), and b^{L}ᵢ is a bias term. Also, N_{w} represents the number of weight coefficients, and φ represents an activation function. When processing indicated by Expression (1) is executed on hardware on a layer-by-layer basis, it is necessary to hold input values X^{L}₀, X^{L}₁, X^{L}₂, . . . , and X^{L}_{Nw-1} in the feature data memory until the calculation of output values X^{L+1}₀, X^{L+1}₁, X^{L+1}₂, . . . , and X^{L+1}_{Nw-1} is completed. Therefore, throughout the entire network, it is necessary to secure a memory area corresponding to the largest value of the sum of feature data sizes on the input-side layer and the output-side layer.

Japanese Patent Application Laid-Open No. 2023-162065 discloses processing in which, with respect to convolutional neural networks (CNNs), which are one type of NN, feature data is processed in such a manner that it is divided on a line-by-line basis, that is to say, in a spatial direction, rather than being processed on a layer-by-layer basis. Here, succeeding layers are preferentially processed, and feature data of each layer is held in a ring buffer. That is to say, instead of holding every line in a feature data memory, only the lines that can be used in computation in succeeding layers are held in the ring buffer, and used lines are sequentially overwritten and discarded. In this way, a processing order is provided so as to reduce the maximum number of lines that are to be held in each ring buffer, and as a result, the amount of memory used can be kept small.

For example, Japanese Patent No. 5171118 and Goetschalckx et al., “Breaking High-Resolution CNN Bandwidth Barriers With Enhanced Depth-First Execution” suggest that a CNN be processed on a line-by-line basis in depth-first order in the layer direction. This can reduce memory usage as a whole, compared to a case where every line is processed on a layer-by-layer basis.

Meanwhile, Transformer found in Vaswani et al., “Attention Is All You Need” and derivatives thereof have been suggested as NN algorithms that are superior in terms of recognition accuracy. For example, an information processing apparatus disclosed in Japanese Patent Application Laid-Open No. 2024-106246 includes a processing unit that divides a feature plane into a plurality of groups in a spatial direction, receives input data irregularly from different positions inside the groups, and performs computation. This processing is executed collectively with respect to every line inside the groups. Therefore, an NN includes both line-based processing and processing that is executed in units of a plurality of consecutive lines, namely band-based processing.

In an NN that includes both line-based processing and band-based processing, if a method that performs control with respect to a single unit of processing as in Japanese Patent Application Laid-Open No. 2023-162065 is used, it will be difficult to reduce memory usage while executing processing, similarly to an NN that is only line-based. In this method, it is possible to process the entire NN on a band-by-band basis by, for example, handling a plurality of lines as one band. On the other hand, this requires computation results to be held in a band-based ring buffer in a processing node in which computation results are originally held in a line-based ring buffer, and this gives rise to the issue that the amount of memory use increases.

### SUMMARY

According to embodiments of the present disclosure, an information processing apparatus is provided that reduces memory usage while executing processing in a neural network that includes different units of processing.

According to some embodiments of the present disclosure, an information processing apparatus that processes computation target data with respect to each of a plurality of processing nodes that are connected in a hierarchical manner in a neural network, the information processing apparatus comprises: a first memory controlling unit configured to hold, in a first partial area in a memory, a first computation result of an end node of each of a plurality of processing node groups obtained by dividing the plurality of processing nodes connected in the hierarchical manner, the first computation result corresponding to a first unit of processing corresponding to a portion of the computation target data computed in a processing node group; and a second memory controlling unit configured to hold, in a second partial area in the memory, a second computation result corresponding to a second unit of processing corresponding to a processing unit included in the first unit of processing, wherein the second memory controlling unit releases the second computation result stored in the second partial area for each computation of the first unit of processing corresponding to the first computation result obtained using the second computation result of the second unit of processing as input.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram showing an example of a functional configuration of an information processing apparatus.

FIG. 2 is a diagram for describing units of processing in a neural network.

FIG. 3 is a diagram for describing units of processing in a CNN according to a first embodiment.

FIG. 4 is a diagram for describing memory allocation and temporal transitions thereof according to the first embodiment.

FIG. 5 is a block diagram showing an example of a hardware configuration of the information processing apparatus.

FIG. 6 is a diagram for describing a determination under a first condition.

FIG. 7 is a diagram for describing a determination under a second condition.

FIG. 8A and FIG. 8B are flowcharts showing an example of processing by the information processing apparatus.

FIG. 9 is a diagram for describing units of processing in a CNN according to a second embodiment.

FIGS. 10A1-3 are diagrams for describing memory allocation and temporal transitions thereof according to the second embodiment.

FIGS. 101-2 are diagrams for describing memory allocation and temporal transitions thereof according to the second embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In each embodiment described below, a neural network (NN) is processed in a hierarchical manner while defining a large unit of processing and a small unit of processing. Units that hold processing and computation results are provided respectively for the two units of processing; consequently, the amount of memory used as a whole is suppressed while executing processing.

### First Embodiment

With respect to a convolutional neural network (CNN), that is to say, a simple NN composed only of convolutional layers, an information processing apparatus according to a first embodiment executes computation processing in a hierarchical manner in two units of processing, namely a first unit of processing created by dividing this NN, and a second unit of processing created by dividing the first unit of processing. Also, the computation results of these respective units of processing are stored in different partial areas in a memory; consequently, processing can be executed while reducing memory usage as a whole. Hereinafter, when the term “information processing apparatus” is simply used, it will be described under the assumption that it refers to an information processing apparatus including a later-described feature data processing unit 507 that executes such processing.

### <Processing of CNN Through Control on Two Layers: Stage-Based and Line-Based Layers>

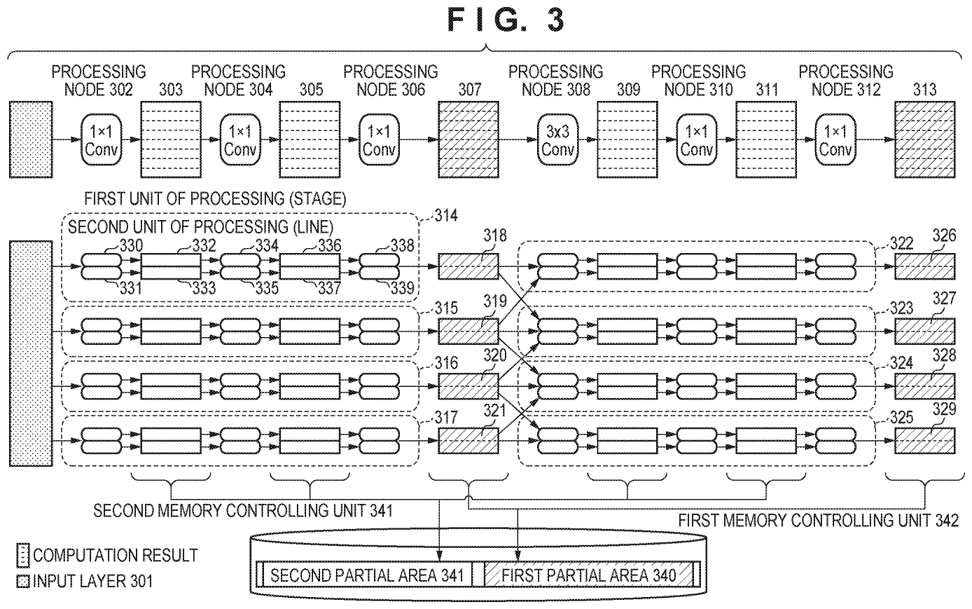

FIG. 3 is a schematic diagram showing an example of a simple CNN composed of six convolutional layers. In this network, an input layer 301 is input, six layers from a processing node 302 to a processing node 312 are processed in series, and a computation result 313 is output. Furthermore, a computation result 303 to a computation result 311 are calculated as intermediate results from five layers from the processing node 302 to the processing node 310, respectively. Although the data sizes of the computation results are shown in the same size for convenience of creation of the diagram, the description of the present embodiment is still applicable even when the data sizes differ among the layers in accordance with a purpose of computation.

In the first embodiment, the NN shown in FIG. 3 is processed in a hierarchical manner with respect to two units of processing, namely a “stage” as the first unit of processing, and a “line” as the second unit of processing. The “line” according to the present embodiment is a unit created by dividing a processing node in a spatial direction. Meanwhile, the “stage” according to the present embodiment is a unit that includes a plurality of consecutive processing nodes and a plurality of consecutive lines.

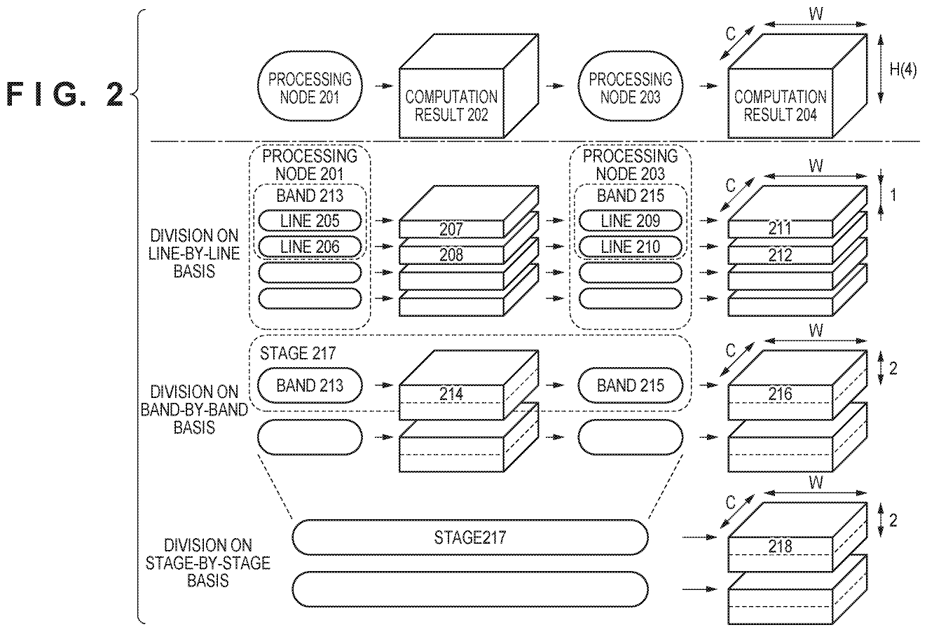

FIG. 2 is a diagram showing a relationship among three units of processing, namely a “stage”, a “band”, and a “line”, in neural network processing according to the present embodiment. It is assumed here that an example of an NN that performs image recognition will be described. It is assumed that each processing node that composes the NN calculates feature data made up of three dimensions, namely a height, a width, and a channel, and represents a computation result thereof. A “line” mentioned here is a unit created by dividing one certain processing node in the height direction. For example, the processing node 201 shown in FIG. 2 calculates a computation result 202 of a height of H×a width of W×C channels. This processing node is regarded as a set of H smaller processing nodes that calculate a computation result 207 of a height of 1×a width of W×C channels, and units of processing of these processing nodes are referred to as “lines”; one of them is referred to as a line 205, and another one of them is referred to as a line 206. A combination of the line 205 and the line 206 forms one larger processing node that obtains a computation result 214 of a height of 2×a width of W×C channels, and a unit of processing of this processing node is referred to as a “band”. It is assumed here that the processing node formed by the combination of the line 205 and the line 206 is referred to as a band 213. Note that although one band is assumed to be a processing node that includes two lines in FIG. 2, the number of lines included in one band is not particularly limited to this, and the number of lines included in one band may be three or more.

It is assumed here that the second unit of processing is a unit of processing (line) created by dividing one processing node, and the first unit of processing is a unit of processing that includes at least one line of each processing node included in one or more consecutive processing nodes among lines that have been divided in such one or more consecutive processing nodes.

Note that although FIG. 2 shows an example in which a line has a height of 1, one line may be equivalent to two pixels or more of feature data in the height direction. In this case, the number of pixels in one band in the height direction is a product of the number of pixels corresponding to the height of one line and the number of lines per band.

The band 213, namely the lines 205 and 206, calculates a band-based computation result 214, namely line-based computation results 207 and 208. Furthermore, while using these computation results as an input, a line 209 and a line 210 included in a band 215 calculate a band-based computation result 216 including line-based computation results 211 and 212. At this time, the bands 213 and 215 are regarded as one large processing node for calculating a computation result 218, and a unit of processing of such a processing node is referred to as a “stage”. Here, a large processing node that calculates the computation result 218 is referred to as a stage 217. Note that although the stage 217 extends across two layers, namely the processing nodes 201 and 203 in FIG. 2, the number of processing nodes included in one stage is not particularly limited to this, and there may be cases where one stage extends across processing nodes in three or more layers.

In the first embodiment, only two units of processing, namely a “stage” and a “line” are handled for simplicity. The NN shown in FIG. 3 is divided into eight stages when processed. Furthermore, each of the stages of the NN shown in FIG. 3 is further divided into six lines when processed.

Each of the processing node 302 to the processing node 312 shown in FIG. 3 is composed of a convolutional layer. An N×N convolutional layer performs convolutional computation that uses an N×N filter with respect to input data. Computation processing in a convolutional layer can be divided into lines as units when executed.

A stage 314 is composed of six lines from a line 330 to a line 339. Inside the stage 314, with respect to four lines from the line 330 to the line 335, a line-based computation result 332 to a line-based computation result 337 are calculated, respectively. Also, a stage-based computation result 318 is calculated as an output from the line 338 and the line 339 (an output of the entire stage 314).

Similarly, in a stage 315 to a stage 317, the input layer 301 is received, and a stage-based computation result 318 to a stage-based computation result 321 are calculated. Furthermore, in a stage 322 to a stage 325, a computation result 307, namely the stage-based computation result 318 to the stage-based computation result 321 are used as an input, and a stage-based computation result 326 to a stage-based computation result 329 are calculated, respectively.

As the processing node 308 is convolutional processing that uses a 3×3 filter, it needs to be provided with, as an input, a computation result at the same position as a computation result to be calculated, and computation results that are immediately thereabove and therebelow. For example, the stage 323 receives three computation results, namely stage-based computation results 318, 319, and 320, as an input.

The information processing apparatus according to the first embodiment holds computation results of the respective stages that are the first unit of processing, and computation results of the respective lines that are the second unit of processing, in different partial areas of the memory. For example, the information processing apparatus holds the stage-based computation result 318 in a first partial area 340. On the other hand, the information processing apparatus holds the line-based computation results 332, 333, 336, and 337 in a second partial area 341. The computation results are stored to and read from the first partial area 340 and the second partial area 341 by a first memory controlling unit 342 and a second memory controlling unit 343 included in the information processing apparatus. Hereinafter, when the term “(first/second) partial area” is simply used, it will be assumed to refer to a partial area in a data holding area of the memory of the information processing apparatus.

The second memory controlling unit 343 can release the second partial area 341 and use this area to hold another computation result each time processing in a stage, which is the first unit of processing, is completed. A line-based computation result that is held in the second partial area 341 in a certain stage is not used as an input in computation processing in another stage. For example, the line-based computation results 332, 333, 336, and 337 are never referred to in computation processing from the stage 315 to the stage 325. Therefore, upon completion of computation processing in the stage 314, the second partial area 341 that holds these computation results can store another computation result through overwriting.

Furthermore, the second memory controlling unit 343 can release a part of the second partial area 341 and use the same to hold another computation result each time processing in a line, which is the second unit of processing, is completed. For example, the line-based computation result 332 is no longer referred after the completion of computation processing in the line 334. Therefore, the second partial area 341 that holds this line-based computation result 332 can store another computation result through overwriting, only in a partial area corresponding to this computation result 332.

Similarly, the first memory controlling unit 342 can release a part of the first partial area 340 and use this part to hold another computation result each time processing in a stage, which is the first unit of processing, is completed. For example, the stage-based computation result 318 is no longer referred to after the completion of computation processing in both of the stage 322 and the stage 323. Therefore, the first partial area 340 that holds this stage-based computation result 318 can store another computation result through overwriting, only in a partial area corresponding to this computation result 318.

With the foregoing configuration, computation results of the first unit of processing and the second unit of processing, which is created by dividing the first unit of processing, are respectively held in the first partial area and the second partial area. Furthermore, here, upon completion of computation in the first unit of processing, it is possible to release (at least a part of) computation results of the second unit of processing included in the first unit of processing, which have been stored in the second partial area. Therefore, as the first memory controlling unit 342 and the second memory controlling unit 343 respectively release areas that will not be referred to in subsequent computation processing with respect to the first partial area 340 and the second partial area 341 on an as-needed basis, the NN shown in FIG. 3 can be processed while reducing memory usage as a whole.

Note that the first memory controlling unit 342 and the second memory controlling unit 343 may physically be the same apparatus as long as they can access both of the first partial area 340 and the second partial area 341 and respectively realize different types of control as described above. For example, in the first embodiment, a later-described processing execution unit 101 accesses each of the first partial area 340 and the second partial area 341 and fulfills the roles of both of the first memory controlling unit 342 and the second memory controlling unit 343.

Furthermore, although the foregoing has described that the entirety of the NN is divided into the first units of processing and every first unit of processing is further divided into the second units of processing as shown in FIG. 3, such division processing need not necessarily be performed with respect to the entirety. It is assumed here that, with respect to one first unit of processing that has been generated through division processing in the NN, one second unit of processing that has been generated through division processing in this first unit of processing is set at least, and a computation result of this one second unit of processing is released at the time of completion of processing of this one first unit of processing.

### <Example of Sequence of Memory Control in CNN>

The following describes an example of a flow in which the first memory controlling unit 342 and the second memory controlling unit 343 store each computation result into the first partial area 340 and the second partial area 341, respectively, and execute processing while releasing these areas on an as-needed basis, in the NN shown in FIG. 3. The information processing apparatus according to the present embodiment can realize processing of the NN shown in FIG. 3 while reducing memory usage as a whole by keeping a sum total of the sizes of the first partial area 340 and the second partial area 341 small.

It is assumed that, with respect to a stage that is the first unit of processing, the information processing apparatus according to the present embodiment processes the network shown in FIG. 3 in the depth-first order (e.g., so as to execute computation processing preferentially for a unit of processing that uses, as an input, a result of computation processing that was completed last). That is to say, the information processing apparatus executes processing in the order of the stages 314, 315, 322, 316, 323, 317, 324, and 325, based on the relationship between the processing node 308 and the computation result 307 required for computation processing thereof.

It is also assumed that, with respect to a line that is the second unit of processing, the information processing apparatus according to the present embodiment executes processing in the depth-first order inside each stage. That is to say, for example, when executing processing inside the stage 314, the information processing apparatus executes processing in the order of the lines 330, 334, 338, 331, 335, and 339. The same goes for a case where processing is executed in the stage 315 to the stage 325.

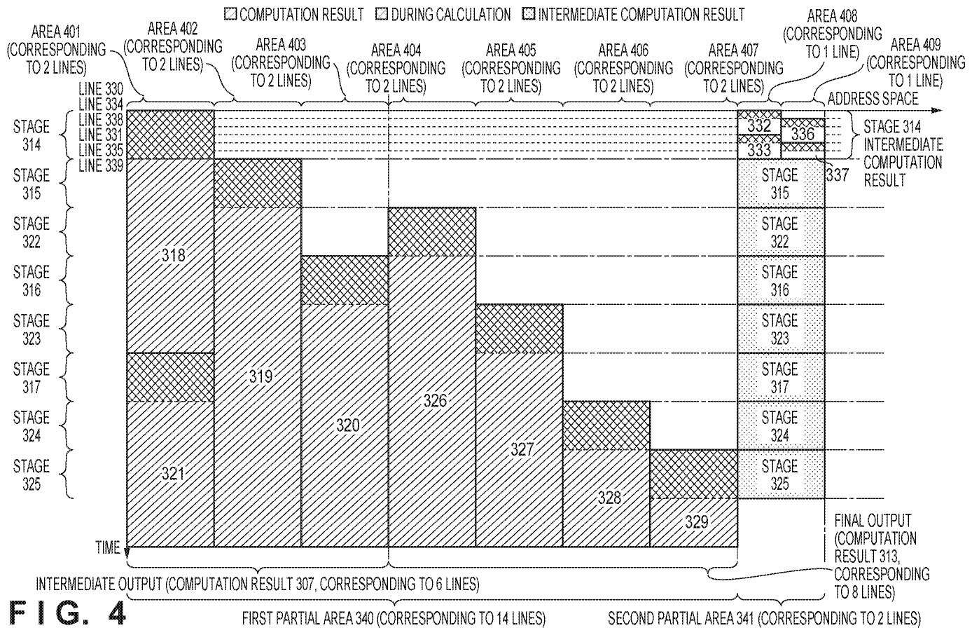

FIG. 4 is a diagram for describing the arrangements of respective computation results in an address space in the memory, and temporal transitions thereof, in the information processing apparatus according to the present embodiment. The processing order of each stage and each line is as described above. The first partial area 340 and the second partial area 341 are allocated in the address space. Note that, to simplify the description, it is assumed that all of the line-based computation results in the NN shown in FIG. 3 have the same data size, and this data size corresponds to one line. It is also assumed that all of the stage-based computation results have the same data size, and this data size corresponds to two lines.

First, the information processing apparatus processes the stage 314. With respect to the stage 314, the first memory controlling unit 342 secures an area 401 corresponding to two lines from the start of the first partial area 340, and stores the stage-based computation result 318. Furthermore, to hold the intermediate computation results inside the stage 314, the second memory controlling unit 343 secures areas corresponding to two lines from the start of the second partial area 341, namely an area 408 and an area 409.

In the course of processing of the stage 314, the second memory controlling unit 343 executes processing of each line inside the stage 314 in order. Here, the second memory controlling unit 343 first processes the line 330. At this time, the second memory controlling unit 343 stores the line-based computation result 332 into the area 408 corresponding to one line from the start of the second partial area 341. Next, the second memory controlling unit 343 processes the line 334, and stores the line-based computation result 336 into the area 409 corresponding to one line, which neighbors the line-based computation result 332. Subsequently, the second memory controlling unit 343 processes the line 338 and calculates the first line of the stage-based computation result 318.

Furthermore, the second memory controlling unit 343 subsequently processes the line 331 and calculates the line-based computation result 333. At this time, the second memory controlling unit 343 stores the line-based computation result 333 by overwriting the area 408 corresponding to one line, in which the line-based computation result 332 is held. As the line-based computation result 332 is referred to as an input to the line 334, the area 408 can be released at the time of completion of the line 334.

Similarly, the second memory controlling unit 343 subsequently processes the line 335, and stores the line-based computation result 337 by overwriting the area 409 corresponding to one line, in which the line-based computation result 336 is held. As the line-based computation result 336 is referred to as an input to the line 338, the area 409 can be released at the time of completion of the line 338.

As the final processing of the stage 314, the second memory controlling unit 343 executes the line 339 and calculates the second line of the stage-based computation result 318. The first memory controlling unit 342 stores the stage-based computation result 318 into the area corresponding to two lines from the start of the first partial area 340.

At this time, the intermediate computation results of the stage 314 stored in the second partial area 341, namely the line-based computation result 333 and the line-based computation result 337 are not referred to in a succeeding stage. Therefore, the second memory controlling unit 343 releases the entire second partial area 341 at the time of completion of the stage 314. Thereafter, the second memory controlling unit 343 repeats the act of holding the intermediate computation results in each stage in the areas corresponding to two lines from the start of the second partial area 341, namely the area 408 and the area 409, and releasing these areas at the time of completion of each stage.

Following the stage 314, the information processing apparatus processes the stage 315. The first memory controlling unit 342 stores the stage-based computation result 319 into the area 402 corresponding to two lines, which neighbors the stage-based computation result 318, in the first partial area 340. Furthermore, the second memory controlling unit 343 holds the intermediate computation results inside the stage 315 in the second partial area 341, and releases them at the time of completion of the stage 315.

Furthermore, the information processing apparatus subsequently processes the stage 322. The first memory controlling unit 342 stores the stage-based computation result 326 into the area 404, which is the seventh line from the start of the first partial area 340, that is to say, which is distanced by two lines from the position of already-existing data. The computation result 313 including the stage-based computation result 326 is equivalent to the final output of the NN shown in FIG. 3. Therefore, the computation result 313 is data that should be held throughout the series of processing, and thus the area thereof is distinguished from the area of the computation result 307, which is an intermediate output. The second memory controlling unit 343 holds the intermediate computation results inside the stage 322 in the second partial area 341, and releases them at the time of completion of the stage 322.

Furthermore, the information processing apparatus subsequently processes the stage 316. The first memory controlling unit 342 stores the stage-based computation result 320 into the area 403 corresponding to two lines, which neighbors the stage-based computation result 319, in the first partial area 340. Furthermore, the second memory controlling unit 343 holds the intermediate computation results inside the stage 316 in the second partial area 341, and releases them at the time of completion of the stage 316.

Furthermore, the information processing apparatus subsequently processes the stage 323. The first memory controlling unit 342 stores the stage-based computation result 327 into the area 405 corresponding to two lines, which neighbors the stage-based computation result 326, in the first partial area 340. Furthermore, the second memory controlling unit 343 holds the intermediate computation results inside the stage 323 in the second partial area 341, and releases them at the time of completion of the stage 323.

Furthermore, the information processing apparatus subsequently processes the stage 317. At this time, the first memory controlling unit 342 stores the stage-based computation result 321 by overwriting the area 401 corresponding to two lines, in which the stage-based computation result 318 is held. As the stage-based computation result 318 is referred to as an input to the stage 322 and the stage 323, this area can be released at the time of completion of the stage 323.

Thereafter, the information processing apparatus processes the stage 324 and the stage 325 in succession. The first memory controlling unit 342 stores the stage-based computation results 328 and 329 respectively into the area 406 and the area 407, which follow the stage-based computation result 327, in units of two lines.

As a whole, the amount of memory used by the first partial area 340 required to hold the stage-based computation results corresponds to 14 lines, which are a total sum of 6 lines for the computation result 307 that is an intermediate output, and 8 lines for the computation result 313 that is a final output. Furthermore, the amount of memory used by the second partial area 341 required to hold the line-based computation results corresponds to two lines. In total, the first embodiment requires the amount of memory used corresponding to 16 lines to process the NN shown in FIG. 3.

In the processing according to the present embodiment, the second memory controlling unit 343 releases the entire second partial area 341 each time a stage is completed; therefore, data of the computation results 303, 305, 309, and 311 corresponding to a total of 32 lines can be processed while repeating the act of holding and releasing the data in units of four lines. Furthermore, out of the second partial area 341, a partial area for which the reference has been completed is released each time a line is completed; therefore, the processing can be executed while holding the aforementioned intermediate computation results corresponding to four lines in an area corresponding to two lines.

Also, similarly, the first memory controlling unit 342 releases a partial area for which the reference has been completed out of the first partial area 340 each time a stage is completed; therefore, data of the computation results 307 and 313 corresponding to a total of 16 lines can be processed while holding the data in an area corresponding to 14 lines.

With respect to each of the first units of processing, the first memory controlling unit 342 according to the present embodiment can hold data by providing, in the second partial area, a circular buffer that takes a computation result of a processing node located at the end of the first unit of processing as an element. Furthermore, the second memory controlling unit 343 according to the present embodiment can hold data by providing, in the first partial area, a circular buffer that takes computation results of processing nodes of the second units of processing that are not located at the end of the first unit of processing as elements.

The first memory controlling unit 342 according to the present embodiment can hold the computation result 307 with use of a circular buffer that takes the areas 401, 402, and 403 as elements. Therefore, when information of the starting address of the first partial area 340, the element sizes of the array, and the array length has been given, the first memory controlling unit 342 can realize the memory allocation shown in FIG. 4 by storing the computation result repeatedly in the order of the areas 401, 402, and 403.

Similarly, the second memory controlling unit 343 according to the present embodiment can hold the computation results 303, 305, 309, and 311 with use of a circular buffer that takes the areas 408 and 409 as elements. Therefore, when information of the starting address of the second partial area 341, the element sizes in the array, and the array length has been given, the second memory controlling unit 343 can realize the memory allocation shown in FIG. 4 by storing the computation result repeatedly in the order of the areas 408 and 409.

Attention should be paid to the fact that the second memory controlling unit 343 according to the present embodiment reduces memory usage by releasing the second partial area 341 for each of the first units of processing. This is an advantageous effect that can be achieved without depending on the processing order of stages and lines shown in FIG. 4. For example, even if the processing order inside the NN shown in FIG. 3 has been changed to the order of the stages 314, 315, 316, 317, 322, 323, 324, and 325, the amount of memory used by the second partial area 341 remains unchanged at two lines.

### <Example of Apparatus Configuration>

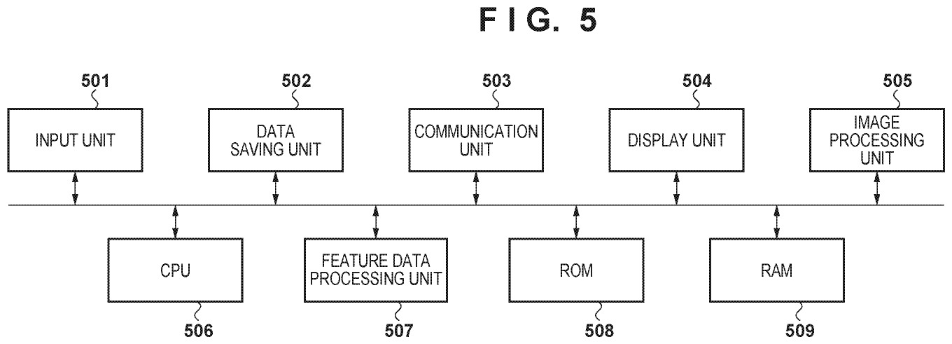

FIG. 5 is a block diagram showing an example of a hardware configuration of the information processing apparatus according to the present embodiment for processing the NN and executing image recognition processing while keeping the amount of memory used small. The information processing apparatus according to the present embodiment includes an input unit 501, a data saving unit 502, a communication unit 503, a display unit 504, an image processing unit 505, a CPU 506, a feature data processing unit 507, a ROM 508, and a RAM 509.

The input unit 501 is an apparatus that accepts instructions or data inputs from a user, and includes, for example, a keyboard, a pointing apparatus, or buttons. Also, for example, the input unit 501 may be implemented in such a manner that the later-described display unit 504 and the input unit 501 compose the same apparatus, such as a known touchscreen apparatus. In this case, an input to the touchscreen is handled as an input to the input unit 501.

The data saving unit 502 is a section in which image data is saved. The data saving unit 502 is normally composed of, for example, a hard disk, a flexible disk, a CD-ROM, a CD-R, a DVD, a memory card, a CF card, SmartMedia, an SD card, a memory stick, an xD picture card, or a USB memory. Other than image data, programs or other types of data can also be saved in the data saving unit 502. Also, a part of the RAM 509 may be used as the data saving unit 502. Furthermore, the data saving unit 502 may be virtually configured; for example, a storage apparatus of a device that has been connected via the later-described communication unit 503 may be used thereas.

The communication unit 503 is an I/F for performing communication between devices. Note that FIG. 3 shows a configuration in which all of the input unit 501, data saving unit 502, and later-described display unit 504 are included in one apparatus.

However, as long as similar functions can be implemented, these components may be connected via communication paths that are based on a known communication method and configured in the foregoing manner as a whole.

The display unit 504 displays images, such as images before image processing and after image processing, and GUIs. In general, a CRT, a liquid crystal display, or the like is used as the display unit 504. Also, the display unit 504 may be a display apparatus that is outside the apparatus and is connected via a cable and the like.

Upon receiving a command from the later-described CPU 506, the image processing unit 505 reads out image data that has been written to the data saving unit 502, and performs range adjustment for pixel values. Also, the image processing unit 505 writes the result of processing to the later-described RAM 509.

The CPU 506 controls the operations of the entire information processing apparatus. The ROM 508 and the RAM 509 provide the CPU 506 with, for example, programs, data, or a working area that are necessary for each type of processing. In a case where a program that is necessary for later-described processing is stored in the data saving unit 502 or the ROM 508, this program is first read into the RAM 509, and then executed. Also, in a case where the information processing apparatus receives a program from outside via the communication unit 503, this program is first recorded into the data saving unit 502, and then read into the RAM 509. Furthermore, such a program may be executed after being read directly from the communication unit 503 directly into the RAM 509. Note that although FIG. 3 shows a configuration in which the information processing apparatus includes only one CPU (CPU 506), a configuration in which a plurality of CPUs are provided is also possible.

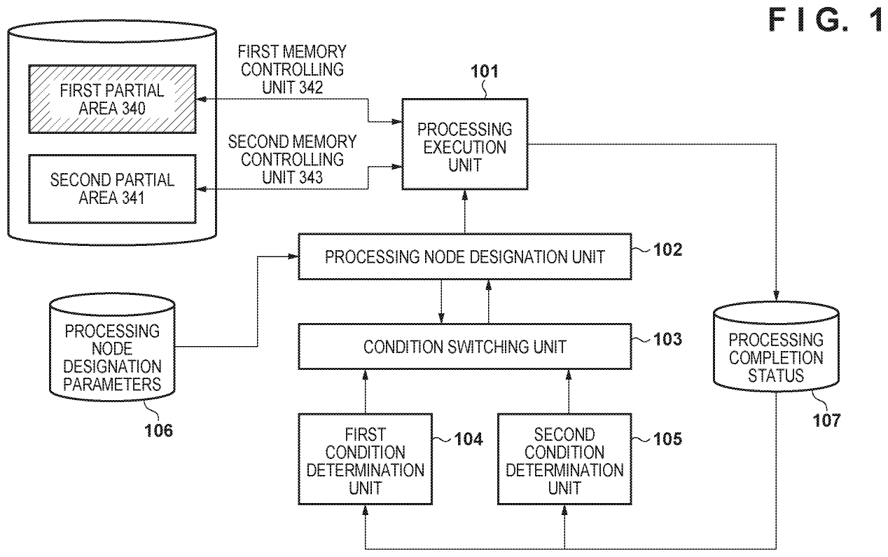

Upon receiving a command from the CPU 506, the feature data processing unit 507 executes computation processing with use of feature data. The feature data processing unit 507 includes an internal storage unit that is necessary for the execution of computation processing, the first memory controlling unit 342, and the second memory controlling unit 343. The first memory controlling unit 342 and the second memory controlling unit 343 respectively secure the first partial area 340 and the second partial area 341 shown in FIG. 1, either in the aforementioned RAM 509 or in the internal storage unit of the feature data processing unit 507. The feature data processing unit 507 performs reading and writing of these in the course of computation processing.

Regarding the system configuration of the information processing apparatus according to the present embodiment, a variety of constituent elements exist other than the ones described above; however, as they are not the focus of the present disclosure, a description thereof is omitted.

### <Exemplary Configuration of Information Processing Apparatus According to Present Embodiment>

With reference to FIG. 1, the following describes a configuration of the information processing apparatus including the feature data processing unit 507 that realizes the memory allocation shown in FIG. 4 in order to process the NN shown in FIG. 3 while reducing memory usage. The following description will be provided in relation to a flow of operations of the feature data processing unit 507, and also in relation to efficient realization of the first memory controlling unit 342 and the second memory controlling unit 343 by the configuration of the feature data processing unit 507 according to the first embodiment.

FIG. 1 is a diagram showing an example of a functional configuration of the information processing apparatus including the feature data processing unit 507 according to the present embodiment. The information processing apparatus includes five constituent elements: a processing execution unit 101, a processing node designation unit 102, a condition switching unit 103, a first condition determination unit 104, and a second condition determination unit 105. Also, processing node designation parameters 106 and a processing completion status 107 are shown as data held in the feature data processing unit 507. The processing node designation parameters 106 and the processing completion status 107 are held in the internal storage unit of the feature data processing unit 507 or the RAM 509.

The processing execution unit 101 executes line-based computation processing in each processing node of the NN shown in FIG. 3. The processing execution unit 101 performs reading and writing of inputs and outputs of the computation processing with use of the first partial area 340 or the second partial area 341. Also, the processing execution unit 101 updates the processing completion status 107 each time the computation processing is completed.

The processing node designation unit 102 designates a processing node for which the processing execution unit 101 executes the computation processing. Also, the processing node designation unit 102 sets parameters that are required for the processing execution unit 101 to execute the computation processing with reference to the processing node designation parameters 106. The processing node designation parameters 106 are parameters indicating the characteristics of the NN including information related to algorithms of the NN, such as the size of feature data and the number of channels of each processing node, and a connection relationship among processing nodes, and it is assumed that these parameters are provided from the outside in advance.

With respect to the processing node designated by the processing node designation unit 102, the condition switching unit 103 provides the processing node designation unit 102 with a result of determination about whether the computation processing in this processing node can be currently executed. The condition switching unit 103 receives this result of determination from the later-described first condition determination unit 104 and second condition determination unit 105, selects the result of determination from one of them, and provides the same to the processing node designation unit 102.

Regarding a stage that is the first unit of processing, the first condition determination unit 104 determines whether the computation processing in the processing node designated by the processing node designation unit 102 can be currently executed based on a first condition, and provides a result of this determination to the condition switching unit 103. The processing completion status 107 provided by the processing execution unit 101 is used in the determination made by the first condition determination unit 104 about whether the computation processing can be executed.

Regarding a line that is the second unit of processing, the second condition determination unit 105 determines whether the computation processing in the processing node designated by the processing node designation unit 102 can be currently executed based on a second condition, and provides a result of this determination to the condition switching unit 103. The processing completion status 107 provided by the processing execution unit 101 is used in the determination made by the second condition determination unit 105 about whether the computation processing can be executed.

The processing execution unit 101 shown in FIG. 1 fulfills the roles of both of the first memory controlling unit 342 and the second memory controlling unit 343 shown in FIG. 3. The processing node designation unit 102 provides the processing execution unit 101 with information necessary for memory control, such as a starting address of an area from/to which the processing execution unit 101 reads/writes a computation result, as parameters. In accordance with switching of parameters provided by the processing node designation unit 102, the processing execution unit 101 stores a computation result of a processing node located at the end of a stage into the first partial area 340, and stores a computation result of an intermediate processing node inside a stage to the second partial area 341.

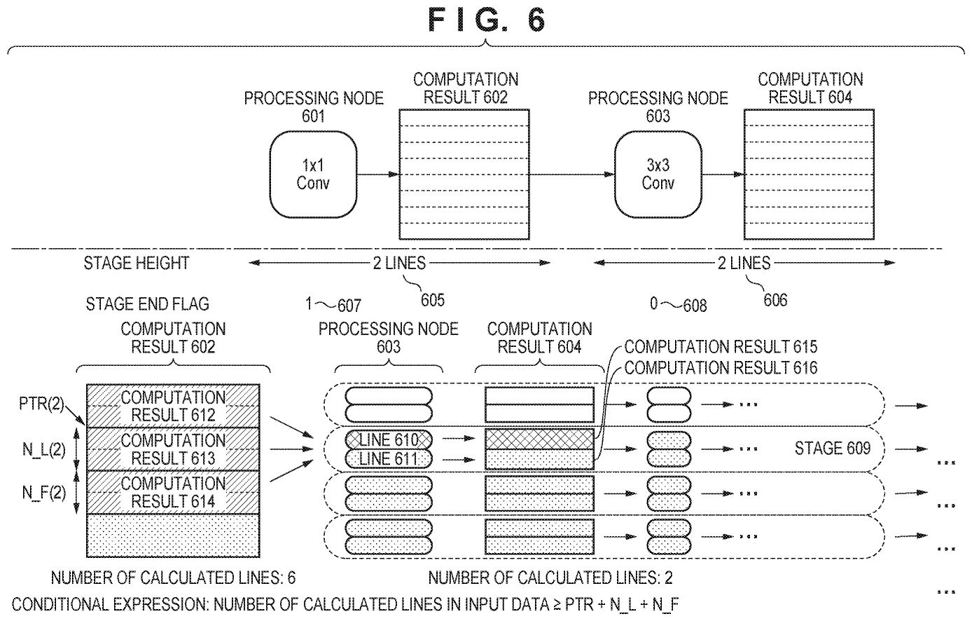

FIG. 6 shows a mechanism of a determination about executability of a processing node that is made by the first condition determination unit 104. The first condition determination unit 104 receives, from the processing node designation parameters 106, parameters that are referred to as a “stage height” and a “stage end flag”, respectively. In the example shown in FIG. 6, with respect to a line 610 that is the third line in a processing node 603, the first condition determination unit 104 determines whether a stage 609, which includes this line, can be executed.

The stage end flag is a parameter designating whether each processing node is located at the end of a stage. As the processing node 601 shown in FIG. 6 is located at the end of a stage, the stage end flag 607 of the processing node 601 is set at 1. On the other hand, as the processing node 603 is not located at the end of a stage, the stage end flag 608 of the processing node 603 is set at 0.

The stage height is a parameter designating the size of each stage in the height direction by counting the size on a line-by-line basis. As the stage including the processing node 601 shown in FIG. 6 executes processing corresponding to a height equivalent to two lines, the stage height 605 of the stage including the processing node 601 is set at 2. Meanwhile, as the stage including the processing node 603 executes processing corresponding to a height equivalent to two lines, the stage height 606 of the stage including the processing node 603 is set at 2.

The first condition determination unit 104 includes three internal variables called PTR, N_L, and N_F. PTR is an internal variable that, with respect to a processing node for which the determination about executability is to be made, designates an index of a calculation-target line in accordance with 0-based numbering. In the example shown in FIG. 6, as the line 610 is the third line in the processing node 603, PTR is set at 2. N_L is an internal variable that, with respect to a processing node for which the determination about executability is to be made, designates the number of lines to be calculated in relation to this unit of processing. In the example shown in FIG. 6, as the stage 609 is to be executed, N_L is set at 2 representing the height of the stage including the processing node 603. N_F is an internal variable that designates a height of a margin in the downward direction, which is required to execute filter processing like convolutional processing. In the example shown in FIG. 6, as the processing node 603 is a convolutional layer with a 3×3 filter, it is necessary to provide thereto not only a stage-based computation result 613 at the same position as the calculation target, but also stage-based computation results 612 and 614 that are immediately thereabove and therebelow, as inputs. Therefore, N_F is set at 2 representing the height of the stage-based computation result 614.

In the first condition determination unit 104, whether the number of calculated lines in a processing node that is input to a processing node for which the determination about executability is to be made is equal to or larger than a sum of PTR, N_L, and N_F, is used as a conditional expression for making the determination about executability of this processing node, that is to say, this stage. If the conditional expression yields true, that is to say, if the number of calculated lines is equal to or larger than the sum of PTR, N_L, and N_F, the first condition determination unit 104 provides a determination result indicating “executable” to the condition switching unit 103. In FIG. 6, the number of calculated lines in a computation result 602, which is input to the processing node 603, is 6. Meanwhile, as the sum of PTR, N_L, and N_F is 6, the conditional expression yields true, and the determination result indicates “executable”.

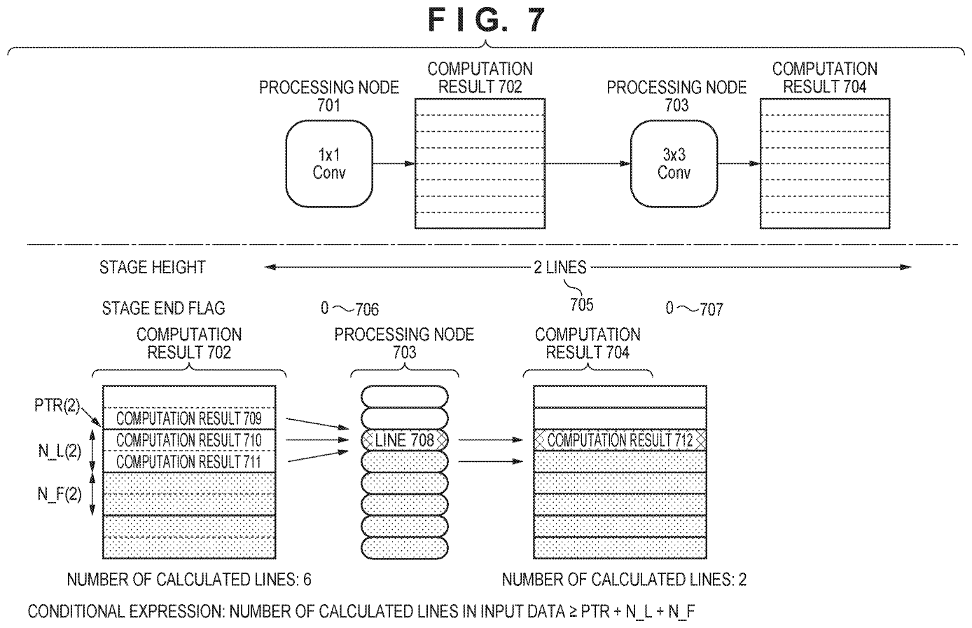

FIG. 7 shows a mechanism of a determination about executability of a processing node that is made by the second condition determination unit 105. Similarly to the first condition determination unit 104, the second condition determination unit 105 refers to a stage height and a stage end flag. In the example shown in FIG. 6, the second condition determination unit 105 determines whether the line 610, which is the third line in the processing node 603, can be executed.

In FIG. 7, as neither a processing node 701 nor a processing node 703 is located at the end of a stage, both of the stage end flag 706 of the processing node 701 and the stage end flag 707 of the processing node 703 are set at 0. Also, it is assumed that both of the processing node 701 and the processing node 703 are included in the same stage, and the stage height 605 is set at 2.

The second condition determination unit 105 includes PTR, N_L, and N_F as internal variables, similarly to the first condition determination unit 104. In FIG. 7, as a line 708 is the third line in the processing node 703, PTR is set at 2. As the line 708 is to be executed, N_L is set at 1. As the processing node 703 is a convolutional layer with a 3×3 filter, it is necessary to provide thereto not only a line-based computation result 710 at the same position as the calculation target, but also line-based computation results 709 and 711 that are immediately thereabove and therebelow, as inputs. Therefore, N_F is set at 1 representing the height of the line-based computation result 711.

Similarly to the first condition determination unit 104, in the second condition determination unit 105, whether the number of lines in a processing node that is input to a processing node for which the determination about executability is to be made is equal to or larger than a sum of PTR, N_L, and N_F, is used as a conditional expression for making the determination about executability of this processing node, that is to say, this line. If the conditional expression yields true, that is to say, if the number of calculated lines is equal to or larger than the sum of PTR, N_L, and N_F, the second condition determination unit 105 provides a determination result indicating “executable” to the condition switching unit 103. In FIG. 7, the number of calculated lines in a computation result 702, which is input to the processing node 703, is 4. Meanwhile, as the sum of PTR, N_L, and N_F is 4, the conditional expression yields true, and the determination result indicates “executable”.

In the above-described manner, the first condition determination unit 104 and the second condition determination unit 105 determine whether a processing node designated by the processing node designation unit 102 can be executed on a stage-based basis and a line-by-line basis, and provides each determination result to the condition switching unit 103. Here, the first condition determination unit 104 and the second condition determination unit 105 include PTR, N_L, and N_F, which are common internal variables, set these values under different logics, and use these values in making the determination about executability.

In the first embodiment, the determination about executability is made in accordance with the conditional expression shown in FIG. 6 in a processing node located at the end of each stage; as a result, a processing order that proceeds to the next stage after processing every line inside a stage is given. The value of PTR in the conditional expression shown in FIG. 6 is not updated until stage-based computation is completed.

Therefore, by using the conditional expressions of FIG. 6 and FIG. 7 separately in accordance with a processing node, the NN shown in FIG. 1 can be processed in the order of processing that extends across two layers, namely stage-based and line-based layers.

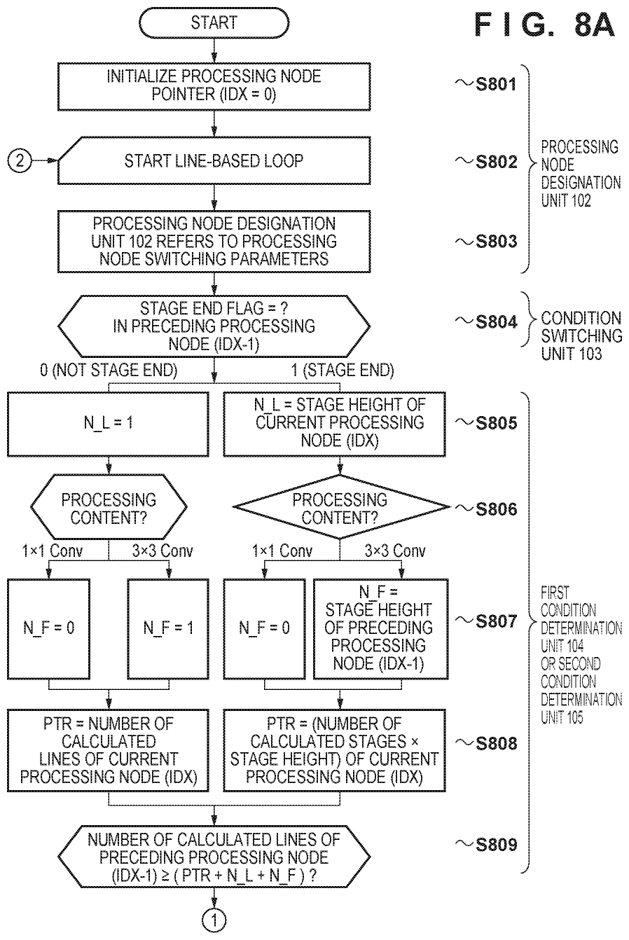

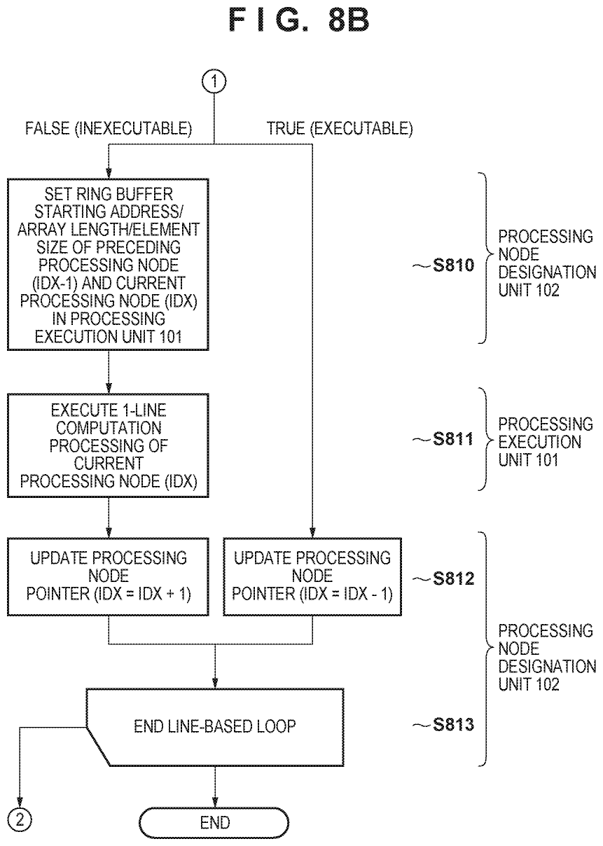

FIG. 8A and FIG. 8B are flowcharts showing an example of information processing in which the feature data processing unit 507 shown in FIG. 1 processes the NN shown in FIG. 3. In this series of processing, the processing execution unit 101 processes the entire NN shown in FIG. 3 by repeating line-based computation processing. Note that the processing shown in FIG. 8A and FIG. 8B may be executed by a constituent element like the processing node designation unit 102 in the feature data processing unit 507, or by a constituent element like the CPU 506 outside the feature data processing unit 507.

In step S801, the processing node designation unit 102 initializes a processing node pointer IDX to 0. The IDX is an index for designating a processing node for which the processing execution unit 101 executes the computation processing. The IDX may be held in an internal storage unit of the processing node designation unit 102, or may be held outside the feature data processing unit 507, like in the RAM 509.

In step S802, the information processing apparatus starts a line-based loop. In the loop that starts from step S802, the line-based computation processing is executed once with respect to the processing node designated by the IDX, or the IDX is switched.

In step S803, the processing node designation unit 102 obtains information necessary for subsequent steps with reference to the processing node designation parameters 106. The processing node designation unit 102 obtains, as an example of information necessary for subsequent steps, a stage height of the node with the index IDX, that is to say, the node that is a processing target, as well as a stage height and a stage end flag of the node with the index IDX-1, that is to say, the node that precedes the processing target (the node that was processed in a preceding phase), and provides them to the condition switching unit 103.

In step S804, the condition switching unit 103 switches subsequent processing with reference to the stage end flag of the node that precedes the processing target. Processing of each of the subsequent steps S805 to S809 is executed by the first condition determination unit 104 if the stage end flag of the processing node designated by the index IDX-1 is 1, and executed by the second condition determination unit 105 if this stage end flag is 0.

In step S805, the first condition determination unit 104 or the second condition determination unit 105 obtains the internal variable N_L included in the conditional expression shown in FIGS. 6 and 7. When the stage end flag of the processing node designated by the index IDX-1 is 0, a line height, namely 1 is set as N_L. When the stage end flag of the processing node designated by the index IDX-1 is 1, the stage height of the processing node designated by the index IDX is set as N_L.

In step S806, the first condition determination unit 104 or the second condition determination unit 105 switches processing in the subsequent step S807. Here, the first condition determination unit 104 or the second condition determination unit 105 switches a calculation expression of the internal variable N_F included in the conditional expression shown in FIGS. 6 and 7 in accordance with the filter size of the convolutional layer.

In step S807, the first condition determination unit 104 or the second condition determination unit 105 calculates the internal variable N_F. When the filter size of the convolutional layer is 1×1, 0 is set as N_F because a margin on the input data side is unnecessary. When the filter size of the convolutional layer is 3×3, 1 is set if the stage end flag of the processing node designated by the index IDX-1 is 0, and the stage height of the processing node designated by the index IDX-1 is set if this stage end flag is 1.

Note that an addition or deletion can be made to the number of branches in switching of processing in step S806 in accordance with the contents of the computation processing supported by the feature data processing unit 507 shown in FIG. 1. Here, the number of branches is described as two because the NN shown in FIG. 3 is composed only of convolutional layers with 1×1 and 3×3 filters. For example, when convolutional layers with a 2×2 filter are additionally supported, it is necessary to add a new calculation expression of N_F in step S807 by adding a branch.

In step S808, the first condition determination unit 104 or the second condition determination unit 105 obtains the internal variable PTR included in the conditional expression shown in FIGS. 6 and 7. When the stage end flag of the processing node designated by the index IDX-1 is 0, the number of calculated lines in the processing node designated by the index IDX is set as PTR. When the stage end flag of the processing node designated by the index IDX-1 is 1, a product of the number of calculated stages and the stage height of the processing node designated by the index IDX is set as PTR. The number of calculated lines and the number of stages of each processing node are held in the processing completion status 107, and are updated by the processing execution unit 101 each time line-based processing is completed.

In step S809, the first condition determination unit 104 or the second condition determination unit 105 determines whether the processing node designated by the index IDX can be executed with use of the conditional expression shown in FIGS. 6 and 7, and provides a result of the determination to the processing node designation unit 102. The content of processing of steps S810 to S812 branches depending on the result of the determination about executability in step S809.

When the result of determination in step S809 indicates “executable”, the processing node designation unit 102 provides the processing execution unit 101 with information necessary for the execution of the computation processing as parameters in step S810. For example, with respect to the processing nodes designated by the index IDX-1 and the index IDX, the processing node designation unit 102 provides the processing execution unit 101 with such information as the starting address, the array length, or the element sizes of a ring buffer that holds computation results.

In step S811, the processing execution unit 101 executes line-based computation processing. Here, the processing execution unit 101 reads/writes computation results from/to the first partial area 340 or the second partial area 341 in accordance with the information that was provided by the processing node designation unit 102 in step S809. Also, the processing execution unit 101 updates the processing completion status 107.

In step S812, the processing node designation unit 102 updates the internal variable IDX that designates a processing node. When the result of the determination about executability in step S809 indicates “executable”, the processing node designation unit 102 increments the IDX by one in order to proceed to a succeeding processing node. When the result indicates “inexecutable”, the processing node designation unit 102 decrements the IDX by one in order to return to the preceding processing node.

In step S813, the processing node designation unit 102 ends the line-based loop, and causes processing to return to step S802 or ends processing shown in FIG. 8A and FIG. 8B. When processing returns to step S802, the processing node designation unit 102 executes the next line-based computation processing in accordance with the index IDX updated in step S812.

In the foregoing manner, the feature data processing unit 507 repeats the execution of the computation processing of the NN shown in FIG. 1 on a line-by-line basis. Due to the determination about executability in step S809 and switching of a condition for determining executability based on a stage end flag in step S804, the order involving two layers, namely stage-based and line-based layers is realized.

In the case of the NN shown in FIG. 3, the processing nodes located at the end of a stage are the processing node 306 and the processing node 312, and thus the stage end flag thereof is set at 1. The stage end flag of other processing nodes 302, 304, 308, and 310 is set at 0. Also, the stage height is set at 2 throughout the entire NN. This makes it possible to execute the computation processing on a line-by-line basis and a stage-by-stage basis in the processing order shown in FIG. 4, and process the entire NN shown in FIG. 3 while reducing memory usage.

Note that the present embodiment has been described in relation to an example in which the feature data processing unit 507 calculates the processing order from the processing node designation parameters 106 in accordance with the flowchart shown in FIG. 8A and FIG. 8B. Meanwhile, such a line-based and stage-based processing order shown in FIG. 4 may be provided directly as the processing node designation parameters 106. When the processing order is calculated from the processing node designation parameters 106, there may be cases where the memory size necessary for holding the processing node designation parameters 106 can be suppressed compared to when the processing order is provided directly as the processing node designation parameters 106.

### Second Embodiment

A second embodiment handles, as an example of an NN that is both band-based and line-based, an NN configured to include band-based processing or addition processing, which is typical in Transformer found in Vaswani et al., “Attention Is All You Need” and in derivatives thereof. Similarly to the first embodiment, an information processing apparatus according to the present embodiment executes processing in a hierarchical manner with respect to two units of processing, namely a “stage” and a “line”, and includes units that hold computation results for the respective units of processing. Therefore, the information processing apparatus according to the present embodiment is also capable of executing processing of the NN while reducing memory usage as a whole.

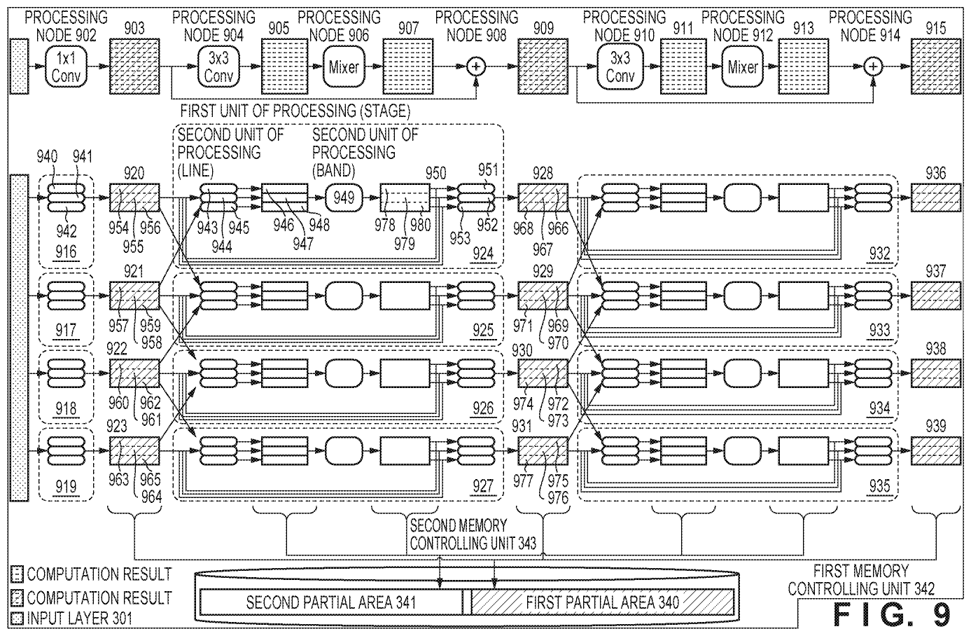

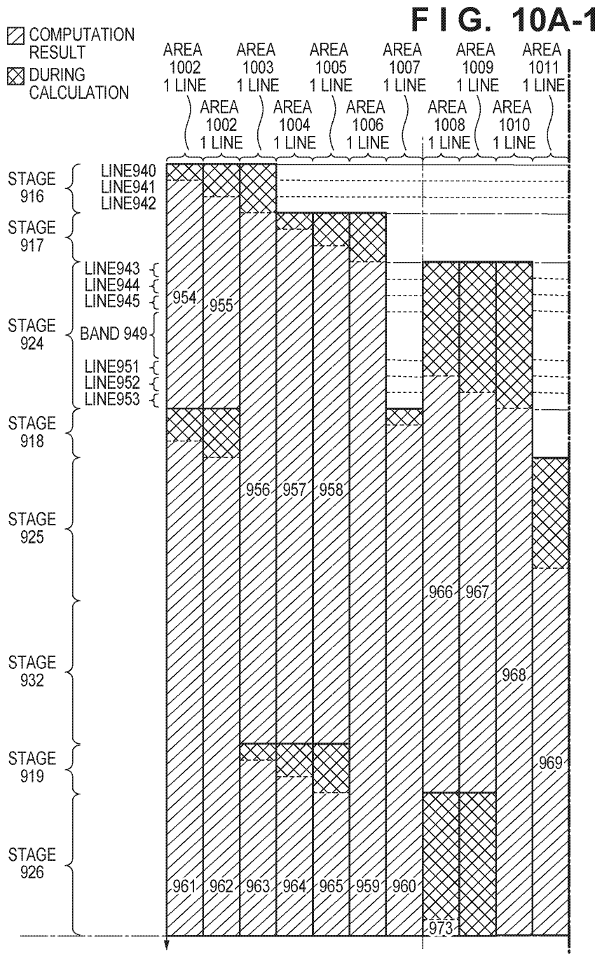

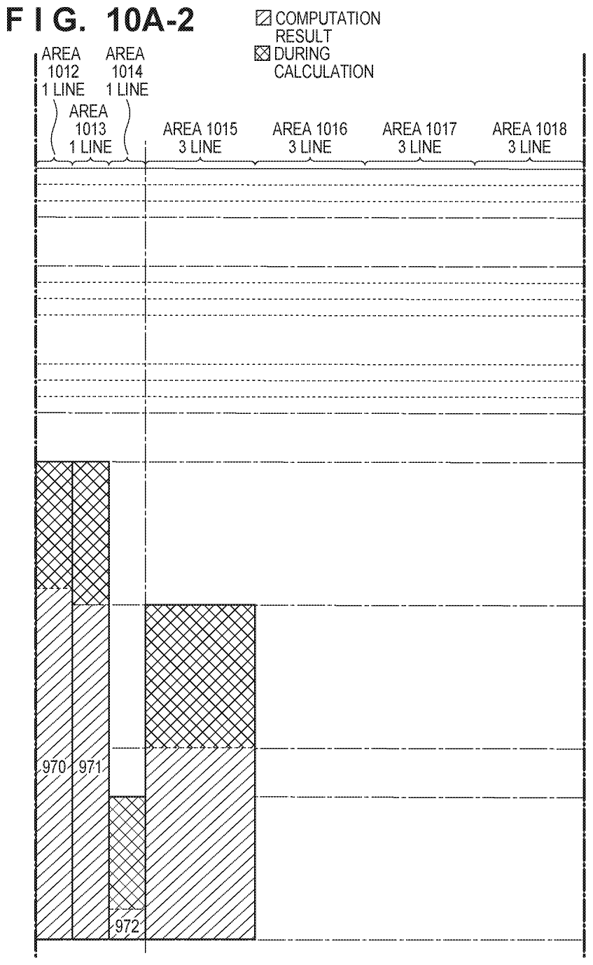

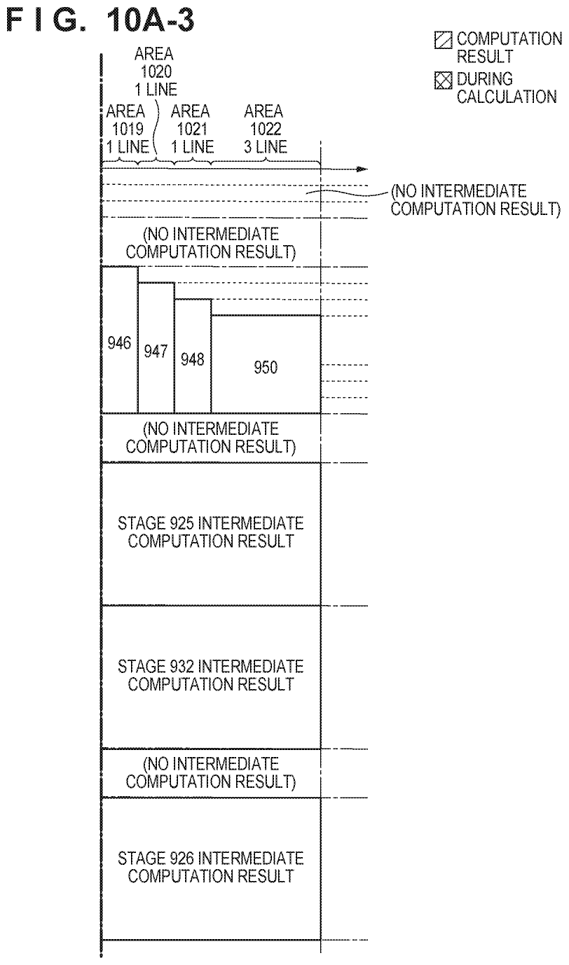

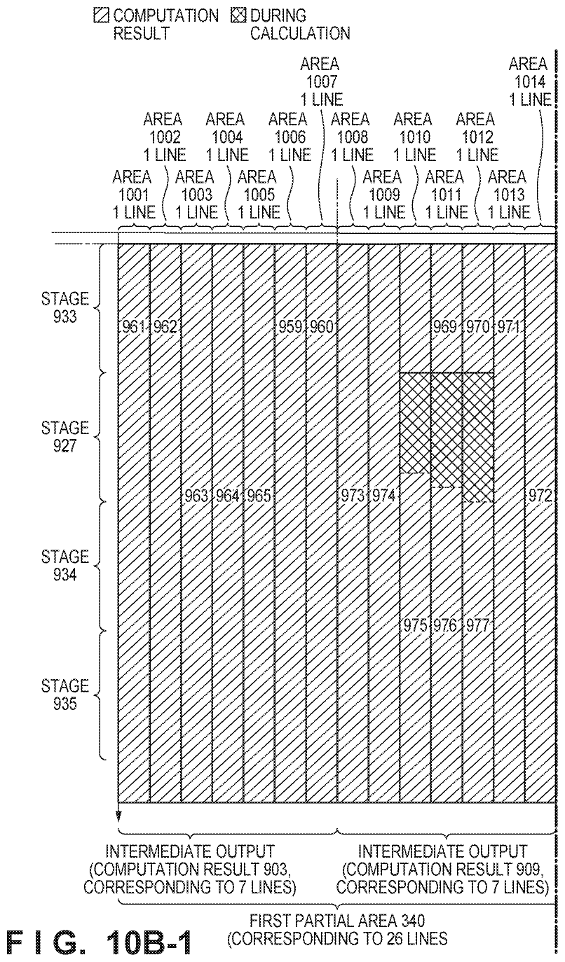

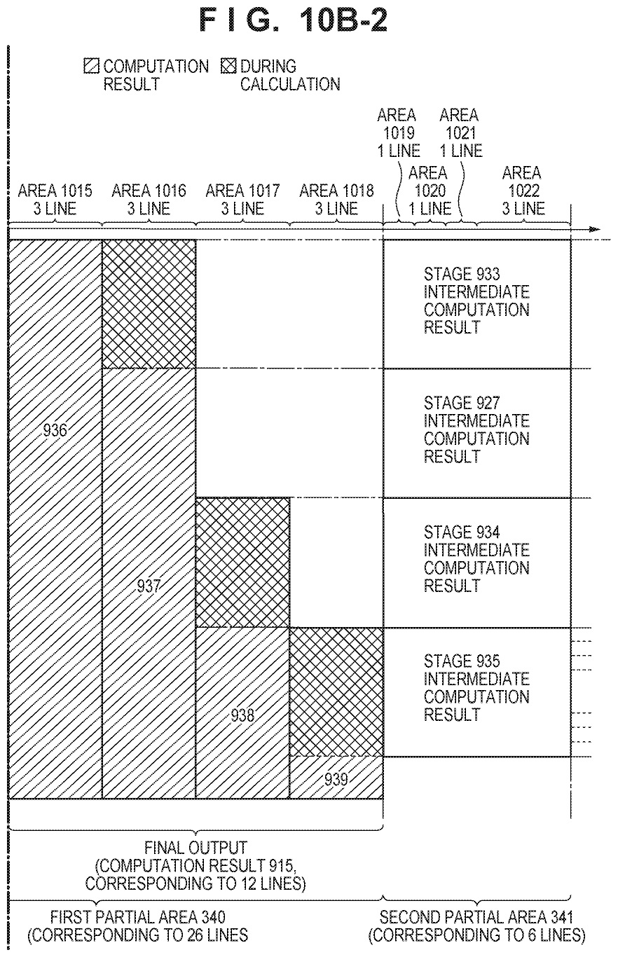

Note that similarly to the first embodiment, the information processing apparatus according to the present embodiment includes various function units including the feature data processing unit 507, and is capable of executing similar processing; therefore, an overlapping description is omitted. In the present embodiment, processing of an NN shown in FIG. 9 is executed in place of the NN shown in FIG. 3. The present embodiment is different from the first embodiment in a method of dividing the NN into first units of processing and second units of processing, as well as allocation and transitions of a memory map. The following describes processing executed by the information processing apparatus according to the present embodiment with reference to FIGS. 9, 10A1-3, and 10B1-2.

### <Processing of NN That is Both Band-Based and Line-Based, Through Control on Two Layers: Stage-Based and Line-Based Layers>

FIG. 9 is a schematic diagram showing an example of an NN that is composed of seven layers and is both band-based and line-based. In this network, an input layer 901 is input, seven layers from a processing node 902 to a processing node 914 are processed in order, and a computation result 915 is output. Furthermore, a computation result 903 to a computation result 913 are calculated as intermediate results by six layers from the processing node 902 to the processing node 912, respectively.

In the present embodiment, the processing node 906 and the processing node 912 are referred to as Mixer layers. In the Mixer layers, band-based input data is received, rearrangement or deformation is performed in a spatial direction or a channel direction, and a multiply-accumulate operation is performed. As processing of the Mixer layers needs to be executed collectively on a band-by-band basis, it is assumed that the processing node 906 and the processing node 912 are band-based processing. Note, it is assumed that one band is equivalent to three lines in each of the processing node 906 and the processing node 912.

In the present embodiment, the processing node 908 and the processing node 914 are referred to as addition layers. The addition layers receive computation results from two processing nodes as inputs, and output a result of adding them. As processing of the addition layers can be executed in any unit of processing, it is assumed that the processing node 908 and the processing node 914 are line-based processing.

Note that as shown in FIG. 9, the processing node 908 adds a computation result 903 and a computation result 907, that is to say, outputs of the processing node 902 and the processing node 906. Also, the processing node 914 adds a computation result 909 and a computation result 913, that is to say, outputs of the processing node 908 and the processing node 912.

A stage 916 is composed only of the processing node 902, and is composed of three lines: a line 940 to a line 942. The stage 916 receives the input layer 901, and calculates a stage-based computation result 920 as outputs of the line 940 to the line 942, and as an output of the entire stage 916.

Similarly, stages 917, 918, and 919 receive the input layer 901, and calculate stage-based computation results 921, 922, and 923, respectively. Each of the stages 917, 918, and 919 is composed of convolutional computation corresponding to three lines.

A stage 924 is composed of the processing nodes 904, 906, and 908. The stage 924 is composed of computation processing corresponding to a total of nine lines, namely three lines from a line 943 to a line 945, one band 949, and three lines from a line 951 to a line 953.

In the present embodiment, regarding stages that are the first units of processing, the scale of computation processing varies on a stage-by-stage basis. For example, the stage 916 is computation processing corresponding to three lines, whereas the stage 924 is computation processing corresponding to nine lines.

Furthermore, in the present embodiment, the scale of computation processing varies also among the second units of processing, similarly to the first units of processing. For example, as the second units of processing, line-based processing for the line 943 is computation processing corresponding to one line, whereas band-based processing for the band 949 is computation processing corresponding to three lines.

In the present embodiment, each of the first unit of processing and the second unit of processing includes different scales of computation processing. Even in this case, units that hold computation results for the two respective units of processing are provided in the neural network processing according to the present disclosure; in this way, processing is executed while reducing memory usage as a whole.

In the stage 924, line-based computation results 946, 947, and 948, which are computation results corresponding to three lines, are calculated from the line 943 to the line 945. Using these as an input, the band 949 calculates a band-based computation result 950. From the line 951 to the line 953, the stage-based computation result 920 and the band-based computation result 950 are input, and a stage-based computation result 928 is calculated on a line-by-line basis.

In the line 951, the first line 954 of the stage-based computation result 920 and the first line 978 of the band-based computation result 950 are added, and the first line 966 of the stage-based computation result 928 is calculated. Similarly, in the line 952, the second line 955 of the stage-based computation result 920 and the second line 979 of the band-based computation result 950 are added, and the second line 967 of the stage-based computation result 928 is calculated. Similarly, in the line 953, the third line 956 of the stage-based computation result 920 and the third line 980 of the band-based computation result 950 are added, and the third line 968 of the stage-based computation result 928 is calculated.

Similarly to the stage 924, in stages 925, 926, and 927, stage-based computation results 929, 930, and 931 are respectively calculated using the input layer 901 as an input. Also, in stages 932, 933, 934, and 935, stage-based computation results 936, 937, 938, and 939 are respectively calculated using the computation result 909, namely stage-based computation results 928, 929, 930, and 931 as an input.

Similarly to the first embodiment, the information processing apparatus according to the present embodiment holds a computation result of each stage, which is the first unit of processing, and a processing result of each line and band, which is the second unit of processing, in different partial areas in the memory. For example, the stage-based computation result 928 is held in the first partial area 340. On the other hand, the line-based computation result 946 and the band-based computation result 950 are held in the second partial area 341.

Similarly to the first embodiment, the second memory controlling unit 343 can release the second partial area 341 each time a stage, which is the first unit of processing, is completed, and use this area to hold another computation result. A line-based computation result that is held in the second partial area 341 in a certain stage is not used as an input in computation processing in another stage. For example, the line-based computation result 946 and the band-based computation result 950 are never referred to in computation processing from the stage 932 to the stage 935. Therefore, the second memory controlling unit 343 enables the second partial area 341 that holds these to store another computation result through overwriting at the time of completion of computation processing in the stage 924.

Also, the first memory controlling unit 342 can release a part of the first partial area 340 and use this part to hold another computation result for each stage, which is the first unit of processing. For example, the stage-based computation result 920 is no longer referred to after the completion of computation processing in both of the stage 924 and the stage 925. Therefore, the first memory controlling unit 342 enables the first partial area 340 that holds this to store another computation result through overwriting, only in a partial area corresponding to the stage-based computation result 920.

On the other hand, the second memory controlling unit 343 according to the present embodiment does not release the second partial area 341 for each line or band, which is the second unit of processing. For example, although the line-based computation results 946, 947, and 948 are not referred to after the completion of processing of the band 949, as the stage 924 does not include processing for storing a computation result into the second partial area 341 in a phase after the band 949, there is no need to release the partial area for storing the line-based computation results 946, 947, and 948. In this way, whether it is necessary for the second memory controlling unit 343 to release the second partial area 341 for each unit of processing should be selected in accordance with the NN that is the processing target, and it is assumed that such a release is unnecessary in the present embodiment.

Through the foregoing processing, the first memory controlling unit 342 and the second memory controlling unit 343 according to the present embodiment release an area that is not referred to in subsequent computation processing on an as-needed basis in the first partial area 340 and the second partial area 341, respectively. This makes it possible to process the NN shown in FIG. 9 while reducing memory usage as a whole.

### <Example of Sequence of Memory Control in NN That is Both Band-Based and Line-Based>

The following describes an example of a flow in which the first memory controlling unit 342 and the second memory controlling unit 343 according to the present embodiment store each computation result in their respective partial areas (the first partial area 340 and the second partial area 341), and execute processing while releasing these areas on an as-needed basis, in the NN shown in FIG. 9. In the present embodiment, processing of the NN shown in FIG. 9 is realized while reducing memory usage as a whole by keeping a sum total of the sizes of the first partial area 340 and the second partial area 341 small.

In the present embodiment, it is assumed that the network shown in FIG. 9 is processed in the depth-first order with respect to a stage, which is the first unit of processing. That is to say, in light of the fact that the processing node 904 and the processing node 910 are convolutional layers with a 3×3 filter, processing is executed in the order of the stages 916, 917, 924, 918, 925, 932, 918, 925, 932, 919, 926, 933, 927, 934, and 935.

With respect to the stage 916 to the stage 919, namely the processing node 902, processing is executed from the top simply in line with the order of arrangement of lines. For example, inside the stage 916, processing is executed in the order of the lines 940, 941, and 942.

Similarly, with respect to the stage 924 to the stage 935 as well, processing is executed from the first in line with the order of arrangement of processing nodes, and from the top in line with the order of arrangement of lines. For example, inside the stage 924, processing is executed in the order of the lines 943, 944, 945, and 949 first, then the band 949, and thereafter the lines 951, 952, and 953. The first partial area 340 and the second partial area 341 are allocated in the address space. Note that, to simplify the description, it is assumed that all of the line-based computation results in the NN shown in FIG. 9 have the same data size, and this data size corresponds to one line. It is also assumed that all of the stage-based computation results have the same data size, and this data size corresponds to two lines.

FIGS. 10A1-3 and 10B1-2 show the arrangements of respective computation results in an address space in the memory and transitions thereof in the time direction according to the present embodiment. The processing order of each stage, each band, and each line is as described above. The first partial area 340 and the second partial area 341 are allocated in the address space. Note that, to simplify the description, it is assumed that all of the line-based computation results in the NN shown in FIG. 9 have the same data size, and this data size corresponds to one line. It is also assumed that all of the band-based and stage-based computation results have the same data size, and this data size corresponds to three lines.

Unlike the first embodiment, the first memory controlling unit 342 according to the present embodiment manages the first partial area 340 on a line-by-line basis. That is to say, the first memory controlling unit 342 according to the present embodiment writes computation results corresponding to one stage, which is three lines here, into the first partial area 340 on a stage-by-stage basis, but releases each stage on a line-by-line basis. As a result, while the amount of memory used required by the first partial area 340 is a multiple of one stage in the first embodiment, there is no need to control the amount of memory used in units of such multiples and the amount of memory used can be further reduced in the present embodiment.

For example, the stages 916, 917, and 918 that include the processing node 902 respectively calculate the stage-based computation results 920, 921, and 922 that each correspond to three lines. The stage 925, which is a convolutional layer with a 3×3 filter, requires the stage-based computation result 921, as well as the stage-based computation results 920 and 922 that are immediately thereabove and therebelow, as an input.

Meanwhile, out of the stage-based computation result 920, only the third line 956 is referred to in the stage 925, and the first line 954 and the second line 955 are no longer referred to after the completion of processing of the stage 924. Therefore, the size of the partial area in the memory that holds the computation result 903 can be reduced from a size corresponding to three states, namely nine lines, to a size corresponding to seven lines.

First, the information processing apparatus processes the stage 916. Regarding the stage 916, the first memory controlling unit 342 secures areas 1001, 1002, and 1003 corresponding to three lines from the start of the first partial area 340, and stores the first line 954, the second line 955, and the third line 956 of the stage-based computation result 920 in order. In the stage 916, there are no processing nodes other than the processing node 902 and intermediate computation results need not to be held, and thus it is not necessary to store data into the second partial area 341.

Similarly, the first memory controlling unit 342 subsequently processes the stage 917. With regard to the stage 917, the first memory controlling unit 342 secures areas 1004, 1005, and 1006 corresponding to three lines that neighbor the third line 956 of the stage-based computation result 920 in the first partial area 340, and stores the first line 957, the second line 958, and the third line 959 of the stage-based computation result 921 in order.

Subsequently, the first memory controlling unit 342 processes the stage 924. With respect to the stage 924, the first memory controlling unit 342 stores the first line 966, the second line 967, and the third line 968 of the stage-based computation result 928 into areas 1008, 1009, and 1010 corresponding to three lines from the seventh line from the start of the first partial area 340.

In the course of processing of the stage 924, processing of each line and each band inside the stage 924 is executed in order. First, the line 943 to the line 945 are processed in order. The second memory controlling unit 343 stores, in order, the line-based processing results 946, 947, and 948 into areas 1019, 1020, and 1021 corresponding to three lines from the start of the second partial area 341.

Following the line 945, the second memory controlling unit 343 processes the band 949. The second memory controlling unit 343 stores the band-based computation result 950 into an area 1022 corresponding to three lines, which neighbors the line-based computation result 948, in the second partial area 341.

Following the band 949, the second memory controlling unit 343 processes the line 951 to the line 953 in order. The computation results of the lines 951, 952, and 953 are equivalent to the first line 966, the second line 967, and the third line 968 of the stage-based computation result 928, respectively.

At this time, the intermediate computation results of the stage 924 stored in the second partial area 341, namely the line-based computation results 946, 947, and 948 and the band-based computation result 950 are not referred to in a succeeding stage.

Therefore, the second memory controlling unit 343 releases the entire second partial area 341 at the time of completion of the stage 924. Thereafter, the second memory controlling unit 343 repeats the act of holding the intermediate computation results in each stage in the areas corresponding to six lines from the start of the second partial area 341, such as the areas 1019, 1020, 1021, and 1022, and releasing these areas at the time of completion of each stage.

Following the stage 924, the first memory controlling unit 342 processes the stage 918. With regard to the stage 918, the first memory controlling unit 342 secures an area 1007 corresponding to one line, which neighbors the third line 959 of the stage-based computation result 920 in the first partial area 340, and stores the first line 960 of the stage-based computation result 921.

Furthermore, the first memory controlling unit 342 stores the second line 961 and the third line 962 of the stage-based computation result 921 through overwriting in the areas 1001 and 1002 corresponding to two lines, which hold the first line 954 and the second line 955 of the stage-based computation result 920. The stage-based computation result 920 is referred to as an input to the stage 925; however, out of the stage-based computation result 920, only the third line 956 is referred to in the stage 925. Therefore, the first line 954 and the second line 955 of the stage-based computation result 920 can be released at the time of completion of the stage 924.

Following the stage 918, the information processing apparatus processes the stage 925. With regard to the stage 924, the first memory controlling unit 342 stores the first line 969, the second line 970, and the third line 971 of the stage-based computation result 929, in order, into the areas 1011, 1012, and 1013 corresponding to three lines, which neighbor the third line 968 of the stage-based computation result 928 in the first partial area 340. Furthermore, the second memory controlling unit 343 holds the intermediate computation results inside the stage 925 in the second partial area 341, and releases them at the time of completion of the stage 924.

Furthermore, the information processing apparatus subsequently processes the stage 932. With respect to the stage 932, the first memory controlling unit 342 stores the stage-based computation result 936 into an area 1015 corresponding to three lines, which follows the 14th line from the start of the first partial area 340. Furthermore, the second memory controlling unit 343 holds the intermediate computation results inside the stage 932 in the second partial area 341, and releases them at the time of completion of the stage 932.

Thereafter, each stage is processed in order in a similar manner. In the rest of the processing node 902, namely the stage 919, the first memory controlling unit 342 overwrites the computation results in units of three lines in a circular manner with respect to the areas 1001 to 1007 corresponding to seven lines from the start of the first partial area 340.

In the rest of the processing node 904 to the processing node 908, namely the stage 926 to the stage 927, the first memory controlling unit 342 overwrites the computation results in units of three lines in a circular manner with respect to the areas 1008 to 1014 corresponding to seven lines, which follow the seventh line of the first partial area 340.

In the rest of the processing node 910 to the processing node 914, namely the stages 933, 934, and 935, the first memory controlling unit 342 stores the computation results in units of three lines in order with respect to the areas 1015 to 1018 corresponding to 12 lines, which follow the 14th line of the first partial area 340.

As a whole, the amount of memory used by the first partial area 340 required to hold the stage-based computation results corresponds to 26 lines, which are a total sum of 7 lines for each of the computation result 903 and the computation result 909 that are intermediate outputs, and 12 lines for the computation result 915 that is a final output. Furthermore, the amount of memory used by the second partial area 341 required to hold the line-based and band-based computation results corresponds to six lines. In total, the information processing apparatus according to the present embodiment requires the amount of memory used corresponding to 32 lines to process the NN shown in FIG. 9.

The second memory controlling unit 343 according to the present embodiment releases the entire second partial area 341 each time a stage is completed; therefore, data of the computation results 905, 907, 911, and 913 corresponding to a total of 48 lines can be processed while repeating the act of holding and releasing the data in units of six lines.

Also, the first memory controlling unit 342 according to the present embodiment releases, on a line-by-line basis, a partial area for which the reference has been completed out of the first partial area 340 each time a stage is completed; therefore, data of the computation results 903, 909, and 915 corresponding to a total of 36 lines can be processed while holding the data in an area corresponding to 26 lines.

Note that in the present embodiment, the computation result 903 can be held with use of a circular buffer that takes the areas 1001 to 1007 as elements. Therefore, when information of the starting address of the first partial area 340, the element sizes of the array, and the array length has been given, the first memory controlling unit 342 can realize the memory allocation shown in FIGS. 10A1-3 and 10B1-2 by storing the computation result repeatedly into the areas 1001 to 1007.

### Other Embodiments

### <Memory Control According to Processing Order (Stages)>

The information processing apparatus according to the first and second embodiments has been described under the assumption that it reduces memory usage by processing each stage of the NN shown in FIGS. 3 and 9 in the depth-first order and holding the stage-based computation results with use of a circular buffer. Meanwhile, the description of the first and second embodiments is not intended to limit the processing order of each stage to the depth-first order in neural network processing executed by the information processing apparatus according to the present disclosure. For example, the information processing apparatus may process the stages of the NN shown in FIG. 3 in the breadth-first order, namely in the order of the stages 314, 315, 316, 317, 322, 323, 324, and 325, and hold the computation result 307 and the computation result 313 in the first partial area 340.

When the stages are processed in the breadth-first order, it is necessary to hold the computation results corresponding to all lines of each processing node in the first partial area 340. Meanwhile, as the number of processing nodes that should be held simultaneously is two at most, processing can be executed while reducing memory usage in the case of, for example, an NN in which the number of lines in each processing node is small and the number of processing nodes is large.

### <Memory Control According to Processing Order (Lines)>

The information processing apparatus according to the first embodiment has been described under the assumption that it reduces memory usage by processing each line inside each stage of the NN shown in FIG. 3 in the depth-first order, and the line-by-line computation results are held with use of a circular buffer. Meanwhile, the description of the first embodiment is not intended to limit the processing order of each line inside each stage to the depth-first order in neural network processing executed by the information processing apparatus according to the present disclosure. For example, the information processing apparatus may process the lines of the stage 314 in the NN shown in FIG. 3 in the breadth-first order, namely in the order of the lines 330, 331, 334, 335, 338, and 339, and hold the line-based computation results 332, 333, 336, and 337 in the second partial area 341.

When the lines are processed in the breadth-first order, the computation results of each processing node that correspond to a stage height need to be held in the second partial area 341. Meanwhile, as the number of processing nodes that should be held simultaneously is two at most, processing can be executed while reducing memory usage when, for example, the NN has been divided using a method that reduces the stage height and increases the number of processing nodes in each stage.

### <Configuration of First and Second Partial Areas>

In the first and second embodiments, the first partial area 340 and the second partial area 341 are provided at different addresses in the same memory, and the first memory controlling unit 342 or the second memory controlling unit 343 performs control in accordance with the memory allocation shown in FIG. 4 or FIGS. 10A1-3 and 10B1-2. Meanwhile, the description of the first embodiment is not intended to limit the physical locations of the first partial area 340 and the second partial area 341 to the same memory in neural network processing executed by the information processing apparatus according to the present disclosure. For example, the second partial area 341 that uses a small amount and is referred to at a high frequency and the first partial area 340 that uses a large amount and is referred to at a low frequency in the memory allocation shown in FIG. 3 may be provided in different physical memories that are respectively appropriate therefor.

### <Method of Providing Processing Node Designation Parameters>

The information processing apparatus according to the first embodiment has been described under the assumption that it provides a stage height and a stage end flag as the processing node designation parameters 106, calculates the processing order of each stage and each line inside the NN shown in FIG. 3 through the flow shown in FIG. 8A and FIG. 8B, and realizes the memory control shown in FIG. 4. Meanwhile, the description of the first embodiment is not intended to limit a method of providing the processing node designation parameters 106 to the foregoing method. For example, the information processing apparatus may provide the processing order of each stage and each line shown in FIG. 4 directly as the processing node designation parameters 106, and the processing node designation unit 102 may control the processing execution unit 101 in accordance with the processing node designation parameters 106.

<Method of Setting Boundary between First Units of Processing>

The information processing apparatus according to the first and second embodiments regards a processing node that immediately precedes a convolutional layer with a 3×3 filter as an end of each stage in the NN shown in FIGS. 3 and 9. Meanwhile, the description of the first and second embodiments is not intended to limit a method of setting a boundary between stages to the foregoing method. For example, the information processing apparatus may newly regard the processing node 302 shown in FIG. 3 as an end of a stage, thereby dividing the stage 314 into a former stage composed of the processing node 302 and a latter stage composed of the processing nodes 304 and 306.

The information processing apparatus can set a boundary between the first units of processing in light of the object of the present disclosure, which is to process the NN while reducing memory usage. For example, a simple NN that is composed only of 1×1 convolutional layers can be divided while regarding any processing node as an end of a stage. At this time, the larger the number of processing nodes that are each located at an end of a stage, the smaller the number of processing nodes included in each stage, and the smaller the amount of memory used by the second partial area 341. On the other hand, the smaller the number of processing nodes that are each located at an end of a stage, the smaller the number of processing nodes that hold a stage-based computation result, and the smaller the amount of memory used by the first partial area 340.

### <Uneven First Units of Processing>

The information processing apparatus according to the first embodiment sets a boundary between stages so that each stage includes three convolutional layers with a 1×1 filter in the NN shown in FIG. 3. Meanwhile, the description of the first embodiment is not intended to limit the contents of computation processing in different stages to the same content. For example, assume a case of processing of an NN that includes former stages and latter stages that are significantly different from each other in configuration in the network, like an NN in which the NN shown in FIG. 3 is succeeded by the NN shown in FIG. 9. In this case, the methods of setting a boundary between stages in the former stages and the latter stages may be similar to those shown in FIGS. 3 and 9, respectively.

The information processing apparatus can set a boundary between the first units of processing in light of the object of the present disclosure, which is to process the NN while reducing memory usage. In the case of the foregoing example, the amount of memory used by the second partial area 341 corresponds to two lines in the former stages and six lines in the latter stages, and it is necessary to secure an area corresponding to the largest value, namely six lines. In this case, there is a possibility to consider finer division of the latter stages than the method shown in FIG. 9 for the purpose of reducing memory usage by the second partial area 341 to less than six lines.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-067036, filed Apr. 15, 2025, which is hereby incorporated by reference herein in its entirety.

What is claimed is:

1. An information processing apparatus that processes computation target data with respect to each of a plurality of processing nodes that are connected in a hierarchical manner in a neural network, the information processing apparatus comprising:
a memory controlling unit configured to:
hold, in a first partial area in a memory, a first computation result of an end node of each of a plurality of processing node groups obtained by dividing the plurality of processing nodes connected in the hierarchical manner, the first computation result corresponding to a first unit of processing corresponding to a portion of the computation target data computed in a processing node group, and
hold, in a second partial area in the memory, a second computation result corresponding to a second unit of processing corresponding to a processing unit included in the first unit of processing; and
release the second computation result stored in the second partial area for each computation of the first unit of processing corresponding to the first computation result obtained using the second computation result of the second unit of processing as input.

2. The information processing apparatus according to claim 1, wherein
among computation results of the second unit of processing, the memory controlling unit allows a computation result that is not referred to in subsequent processing in processing of the neural network to be released as the second computation result.

3. The information processing apparatus according to claim 2, wherein
among computation results of the first unit of processing, the memory controlling unit allows release of a computation result that is not referred to in subsequent processing in the processing of the neural network.

4. The information processing apparatus according to claim 1, further comprising:
a computation unit configured to perform computation in units of the second unit of processing; and
a setting unit configured to set a processing order of the computation performed in the second unit of processing by the computation unit,
wherein the setting unit sets the processing order of the computation so as to minimize a total amount of memory used for computation results of the first unit of processing and computation results of the second unit of processing that are held in the memory.

5. The information processing apparatus according to claim 4, wherein
the setting unit sets the processing order of the computation so that, with respect to computation processing in the first unit of processing, the computation processing is executed preferentially if the first unit of processing uses a result of immediately previously completed computation processing as input.

6. The information processing apparatus according to claim 4, further comprising:
a first determination unit configured to determine, based on a first condition, whether a processing node included among the plurality of processing nodes is executable;
a second determination unit configured to determine, based on a second condition different from the first condition, whether a processing node included among the plurality of processing nodes is executable; and
a third determination unit configured to determine which one of the first determination unit and the second determination unit is to be used in determining whether a processing target processing node included among the plurality of processing nodes is executable, based on a processing node processed immediately before the processing target processing node, and on a parameter provided in advance and indicating a characteristic of the neural network.

7. The information processing apparatus according to claim 6, wherein
based on the parameter provided in advance and indicating the characteristic of the neural network, the third determination unit determines that the determination of whether the processing target processing node is executable is to be made by the first determination unit in a case where the processing node that immediately precedes the processing target processing node is a processing node corresponding to an end of the first unit of processing, and determines that the determination is to be made by the second determination unit in a case where the processing node that immediately precedes the processing target processing node is a processing node not corresponding to an end of the first unit of processing.

8. The information processing apparatus according to claim 1, wherein
the second unit of processing is a unit of processing obtained by dividing one of the plurality of processing nodes, and
the first unit of processing is a unit of processing that includes at least one second unit of processing divided from each of one or more consecutive processing nodes included among the plurality of processing nodes.

9. The information processing apparatus according to claim 8, wherein
for each processing node corresponding to an end of the first unit of processing, the memory controlling unit provides, in the first partial area, a circular buffer that takes a computation result of each first unit of processing as an element.

10. The information processing apparatus according to claim 8, wherein
for each processing node not corresponding to an end of the first unit of processing, the memory controlling unit provides, in the second partial area, a circular buffer that takes a computation result of each second unit of processing as an element.

11. The information processing apparatus according to claim 8, wherein
for each processing node corresponding to an end of the first unit of processing, the memory controlling unit provides, in the first partial area, a circular buffer that takes, as an element, data obtained by a computation result of each first unit of processing being divided into the second unit of processing.

12. An information processing method for processing computation target data with respect to each of a plurality of processing nodes that are connected in a hierarchical manner in a neural network, the information processing method comprising:
holding, in a first partial area in a memory, a first computation result of an end node of each of a plurality of processing node groups obtained by dividing the plurality of processing nodes connected in the hierarchical manner, the first computation result corresponding to a first unit of processing corresponding to a portion of the computation target data computed in a processing node group; and
holding, in a second partial area in the memory, a second computation result corresponding to a second unit of processing corresponding to a processing unit included in the first unit of processing,
wherein the second computation result stored in the second partial area is released for each computation of the first unit of processing corresponding to the first computation result obtained using the second computation result of the second unit of processing as input.

13. A non-transitory computer-readable recording medium storing a program for causing a computer to execute an information processing method for processing computation target data with respect to each of a plurality of processing nodes that are connected in a hierarchical manner in a neural network, the information processing method comprising:
holding, in a first partial area in a memory, a first computation result of an end node of each of a plurality of processing node groups obtained by dividing the plurality of processing nodes connected in the hierarchical manner, the first computation result corresponding to a first unit of processing corresponding to a portion of the computation target data computed in a processing node group; and
holding, in a second partial area in the memory, a second computation result corresponding to a second unit of processing corresponding to a processing unit included in the first unit of processing,
wherein the second computation result stored in the second partial area is released for each computation of the first unit of processing corresponding to the first computation result obtained using the second computation result of the second unit of processing as input.
